(19) United States
(12) Patent Application Publication
(10) Pub. No.: US 2008/0231107 A1
(43) Pub. Date: Sep. 25, 2008

(54) Vehicle Wheel

(76) Inventor: Stephen Michael Ascough, West Yorkshire (GB)

Correspondence Address: WILLIAM DOUGLAS HARE, 3 ANDERSON LANE, PRINCETON, NJ, 08540, US

(21) Appl. No.: 12/064,815

(22) PCT Filed: Aug. 21, 2006
(86) PCT No.: PCT/GB2006/003109

§ 371 Date: Feb. 25, 2008

(30) Foreign Application Priority Data
Aug. 26, 2005 (GB) 0517569.0
Jun. 3, 2006 (GB) 0610969.8

(51) Int. Cl. B60B 19/00

(52) U.S. Cl. 301/111.01

(57) ABSTRACT

There is described a vehicle wheel for use in the recovery of vehicles, the wheel having a central opening and one or more apertures disposed around the central opening for attachment of the wheel to a vehicle axle, wherein the apertures take the form of slots, the slots having a length and being oriented to extend radially from the wheel axis. There is also described a kit comprising a plurality of such wheels, a method of recovering a vehicle using such wheels and a process of manufacturing such a wheel.

The present invention relates to vehicle wheels and more particularly, although not exclusively, to wheels for use during the recovery of road vehicles.

The present invention relates to UK Patent Application 0517569.0, the details of which are incorporated herein by reference.

It is often necessary for a vehicle to be recovered upon occurrence of a fault or else an accident. When a vehicle is to be recovered, it is generally rolled on to the back of a truck to be carried to the required destination. This does not cause a particular problem for the majority of vehicle faults which can occur. However it is frequently encountered by the recovery service provider that the vehicle which is to be recovered is lacking the use of one or more wheels. This may be due to theft or else damage to the wheel or wheels, for which the vehicle owner does not have a replacement wheel.

In such instances it becomes difficult, if not impossible to roll the vehicle onto a truck as required. In addition, attempts to move a vehicle onto the back of a truck without a full complement of wheels can result in further damage over and above the mere lack of one or more wheels. If the vehicle cannot be moved, then the recovery truck must return to the workshop to bring a wheel of the correct type for attachment to the vehicle. Call-outs of this nature form a substantial percentage of vehicle recoveries and so this is known to be a common problem, which causes significant expense to the recovery services provider.

It is generally therefore accepted that the vehicle recovery provider needs to ascertain whether a wheel will be required in advance of sending out a recovery vehicle. Furthermore a vehicle recovery provider must carry at least one wheel in stock for the majority of different vehicle makes and models. This is due to the differences in the attachment configuration and the size of the wheel for different road vehicles. It will be appreciated that this places a burden on the recovery services provider and, even if precautionary measures are take, there will inevitably be some call-outs of this nature which result in it being impossible to recover the vehicle in question.

In view of the foregoing problems, the present invention aims to provide a vehicle wheel which provides a substitute for a standard wheel for multiple different vehicle makes and models during vehicle recovery.

According to the present invention there is provided a vehicle wheel for use in the recovery of vehicles, the wheel having a central opening and one or more apertures disposed around the central opening for attachment of the wheel to a vehicle axle, wherein the apertures take the form of slots, the slots having a length and being oriented to extend radially from the wheel axis.

Advantageously the slots are range-taking such that they can be correctly aligned for fixing to vehicle wheel hubs which cater for wheels of differing diameters.

Typically the slots are arranged to allow for either 3, 4 or 5 stud fixing arrangements. Typically the wheel comprises a set of slots, spaced by 120° around the central opening. The wheel may comprise a set of slots spaced by 90° around the central opening. The wheel may comprise a set of slots spaced by 72° around the central opening. According to a preferred embodiment, the wheel has ten slots arranged in three sets with angular spacing as defined above. Typically one slot is common to two or more sets. Alternatively, the slots may be arranged to allow for 6 stud fixing arrangements such that the wheel comprises a set of slots, spaced by 60° around the central opening.

Preferred embodiments of the invention are described in further detail below with reference to the accompanying drawings in which:

FIG. 1 is a plan view of a wheel according to the present invention;

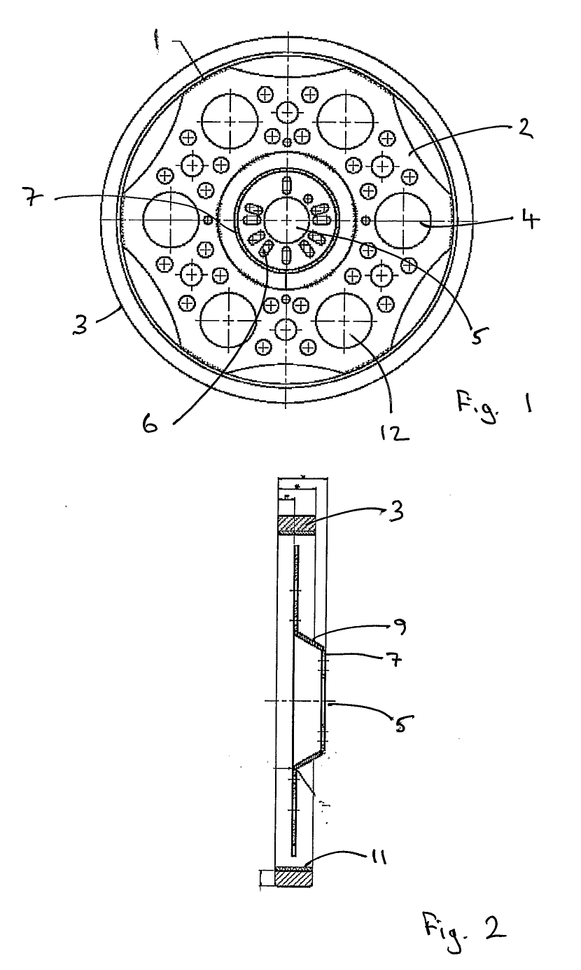

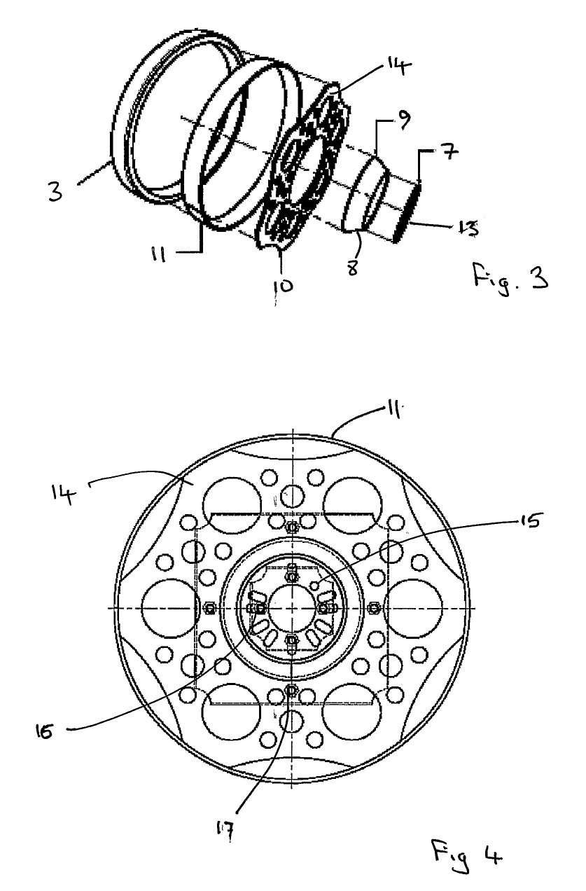

FIG. 2 is a cross section of the wheel of FIG. 1 taken through the plane A-A;

FIG. 3 is an exploded view of the wheel of FIG. 1;

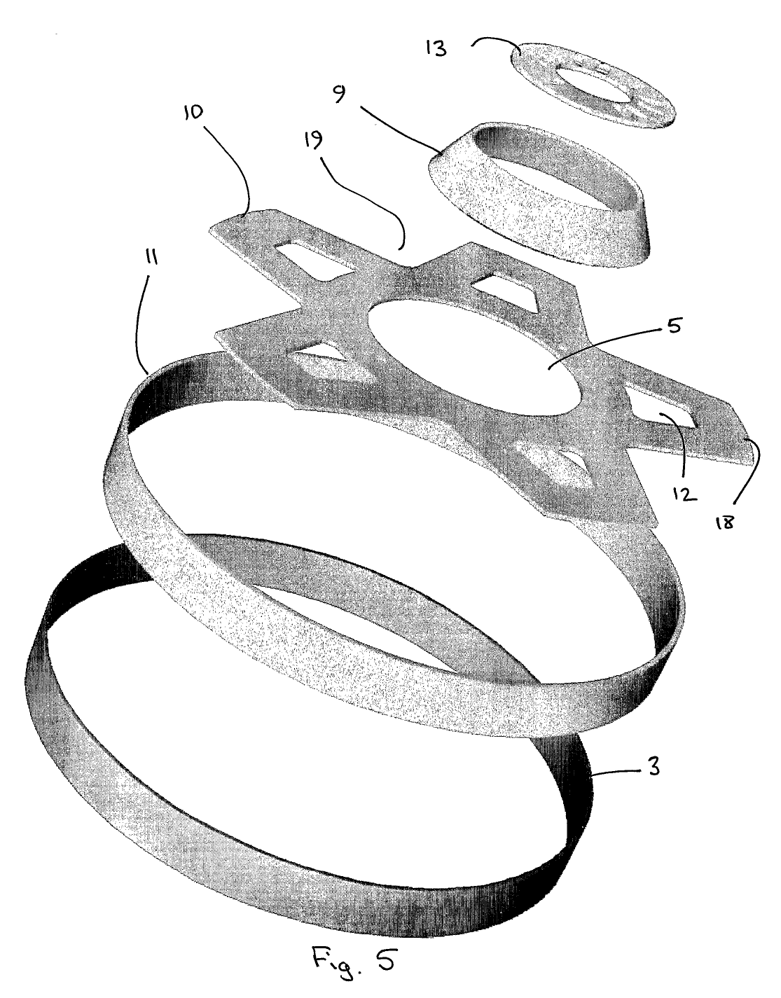

FIG. 4 is a plan view of a wheel according to the present invention when located for use;

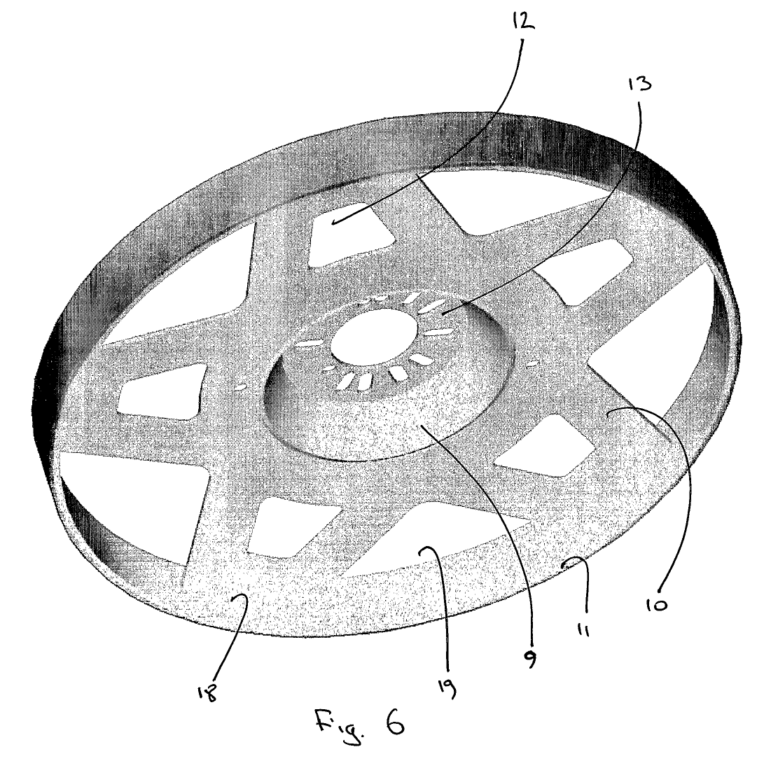

FIG. 5 is a perspective view of a disassembled wheel according to a further embodiment of the invention; and

FIG. 6 is a perspective view of the assembled wheel of FIG. 5.

FIG. 1 shows a recovery wheel (1) according to the present invention which has a central portion (2) surrounded by an outer tyre (3). The central portion (2) is substantially formed of sheet metal with a number of apertures (4) therethrough. In particular the central portion (2) is provided with a central opening (5), the axis of which is aligned with the wheel axis (not shown).

Disposed around the central opening (5) are a series of 10 slots (6). Each slot (6) is elongate in shape and arranged such that the length of each slot (6) extends radially from the wheel axis. Thus each slot (6) can be said to extend away from the wheel axis along an imaginary radial line. The slots (6) are circumferentially spaced around the central opening (5) to provide 3 sets of equally-spaced radial slots (6). The central opening (5) and the slots (6) are provided within a wheel hub portion (7).

The hub portion (7) is connected to the tyre (3) by one or more annular portions (8) in the embodiment shown, the annular portions (8) comprise a tapered ring (9) and a connection portion (10) extending radially between the tapered ring (9) and an outer rim (11).

The tapered ring (9) has a depth, such that the hub portion (7) is disposed within a plane which is generally parallel with but offset from the plane of the connection portion (10).

In the embodiment shown the connection portion (10) contacts the outer rim (11) at a number of discrete locations around the circumference of the connection portion (10). However in an alternative embodiment, the connection portion (10) and the outer rim (11) may be joined substantially around 360°. In the embodiment shown, the connection portion (10) is provided with a series of ears or lips which extend into correspondingly shaped grooves or slots within the rim so as to ensure correct orientation of the two portions. The slot arrangement is also preferred since it prevents the join between the connection portion (10) and the rim (11) being exposed. The connection portion (10) is provided with a series of apertures (12) therein in order to reduce the overall weight of the wheel (1) and also to provide openings by which a user can easily grip the wheel.

As shown in FIG. 2, the rim (11) has a depth sufficient to accommodate the width of the tyre (3). Exemplary dimensions for the wheel (1) can be provided as follows:

| | | |
|---|---|---|
| Overall diameter including tyre: | 600 | mm |
| Depth of rim/tyre width: | 60 | mm |
| Depth of tapered ring: | 49 | mm |

As shown in FIGS. 2 and 3 the wheel (1) can be seen to generally comprise a central hub plate (13), a tapered/frusto conical ring (9), a connection portion (10) in the form of an outer plate (14), an outer rim (11) and a tyre (3). Excluding the tyre (3), the wheel (1) is generally made from plate steel with thickness of roughly 6 mm, preferably 5 mm.

The diameter and the innermost edge of the slots is 85 mm and the diameter at the outermost edge of the slots (6) is 142 mm. Thus each slot (6) has a length of 28.5 mm. The length of the slots (6) as well as the arrangement thereof around the wheel axis allows the wheel (1) according to the present invention to be fitted to the majority of makes and models of cars.

Therefore a vehicle recovery service provider need only carry a single set of wheels according to the present invention rather than requiring different wheels for different makes and models of vehicle. Thus a vehicle recovery service provider can be confident that they will be able to recover substantially any vehicle without the need to verify the make and model of the vehicle in question. In addition the recovery wheels according to the present invention are substantially lighter and less bulky than conventional wheels. The present invention takes advantage of the fact that a wheel need only travel a number of meters in order to be recovered which is in contrast to the general use of the vehicle which requires wheels be subject to far greater specifications.

In addition to the slots (6), the hub portion (7) is provided with an additional opening in the form of a circular hole (15) which is offset from the central opening (5). This additional hole (15) may be provided with locating bolt extending from the axle hub so as to ensure correct positioning of the wheel (1) on the wheel hub/axle of the vehicle and is to allow for a protrusion fitted to certain makes of cars, e.g. Citroen and Fiat.

Within the connecting portion (10), an additional set of four apertures (16) are optionally provided, spaced by 90°. These additional apertures (16) allow for attachment of the connecting portion (10) to a jig for welding via holes which are located outside the range of the slots. FIG. 4 shows the arrangement of bolts (17) for attachment of the central hub plate (13) and connecting portion (10) to a welding jig.

It will be appreciated that the welding jig is attached to the central wheel hub in the same way as would a vehicle axle hub using a four stud arrangement. It can be seen that only one set of the locating slots is required and that the remaining six slots would not be used in this instance.

FIGS. 5 and 6 shows an alternative embodiment of the wheel (1) which generally comprises a central hub plate (13), a tapered/frusto conical ring (9), a connection portion (10), an outer rim (11) and a tyre (3). In this embodiment the connection portion (10) is generally “star” shaped and comprises a central opening (5) for engagement with the frusto conical ring (9) and five connecting regions (18) for location in or against the outer rim (11). The region (19) adjacent each of the connecting regions (18) is substantially cut away, further reducing the weight of the wheel (1). The apertures (12) are generally trapezoid in shape providing the desired reduction in weight of the wheel whilst increasing the load bearing capacity.

The manufacture of the recovery wheel according to the present invention will now be described in accordance with the embodiments shown in FIGS. 1-4. However, it will be appreciated that a number different manufacturing methods are available and could usefully be adopted. In particular, one cost effective method of manufacture would involve pressing a metal sheet into shape using a die arrangement so as to form each of the hub portion, the tapered ring, the connection portion and the outer rim integrally using a single piece of sheet steel. Alternatively the wheel could be formed as a single piece by way of injection moulding and may not necessarily be made of metal.

Turning now to the manufacture of the embodiments shown in FIGS. 1-4, the hub portion is first assembled onto a jig and is welded around its circumference to the narrowest edge of the tapered ring portion. The outer edge of the tapered ring portion is then welded to the inner edge of the connection portion and subsequently the outer edge of the connection portion is welded to the rim. The partially finished wheel is then typically removed from the jig and inverted such that the rear side of the wheel can be correspondingly welded as described. The parts are typically fillet welded. Each part may be welded substantially around its entire circumference or else may be welded along discrete sections thereof at equal spacings. Once welding is complete, the tyre can then be attached to the outer surface of the rim such that the recovery wheel is ready for use.

It will be understood by one skilled in the art that alternative methods of manufacture may also be possible. In addition to the use of materials such as pressed steel, sheet metal and injection moulded plastics; cast, spun and/or machined materials may also be utilised.

Whilst the above embodiments have been disclosed with a degree of particularity, it is to be noted that a number of dimensions of the recovery wheel will be changed substantially without effecting operation thereof. In this regard, it has been found that the depth of the tapered portion is contained within a volume defined by the depth of the rim. The purpose of the (49 mm) step of the tapered ring is to allow clearance over, e.g. brake callipers and/or for ease of manufacture. Furthermore, the recovery wheel is stable when laid down on a flat surface and is not subject to wobbling during manufacture or else storage thereof

In addition, the wheel can be made lighter or stronger to suit different applications so as to accommodate for larger vehicles, such as for example caravans. The above embodiment is intended for fixation to the majority of road vehicles. However, specifically in the case of 4×4 vehicles, there is sometimes a need to accommodate a six stud fixing arrangement. In such an instance, it can be seen that four of the six required slots can be provided by way of the above embodiment. Thus an additional two slots could be provided as required or else a specific recovery wheel could be provided for 4×4 vehicles as necessary. The recovery wheel of the invention may optionally be rust proofed, e.g. by powder coating.

1. A vehicle wheel for use in the recovery of vehicles, the wheel having a central opening and one or more apertures disposed around the central opening for attachment of the wheel to a vehicle axle, wherein the apertures take the form of slots, the slots having a length and being oriented to extend radially from the wheel axis.

2. A vehicle wheel according to claim 1 wherein the slots are range-taking such that they can be correctly aligned for fixing to axles which cater for wheels of differing diameters.

3. A vehicle wheel according to claim 1 wherein the slots are arranged to allow for either 3, 4 or 5 stud fixing arrangements.

4. A vehicle wheel according to claim 1 wherein the wheel includes a six stud fixing arrangement.

5. A vehicle wheel according to claim 3 wherein the wheel comprises a set of slots, spaced by 120° around the central opening.

6. A vehicle wheel according to claim 3 wherein the wheel comprises a set of slots spaced by 90° around the central opening.

7. A vehicle wheel according to claim 3 wherein the wheel comprises a set of slots spaced by 72° around the central opening.

8. A vehicle wheel according to claim 4 wherein the wheel comprises a set of slots spaced by 60° around the central opening.

9. A vehicle wheel according to claim 1 wherein the wheel has ten slots arranged in three sets with angular spacing.

10. A vehicle wheel according to claim 1 wherein one slot is common to two or more sets.

11. A vehicle wheel according to claim 1 wherein disposed around the central opening are a series of 10 slots.

12. A vehicle wheel according to claim 1 wherein each slot is elongate in shape and arranged such that the length of each slot extends radially from the wheel axis.

13. A vehicle wheel according to claim 12 wherein the slots are circumferentially spaced around the central opening to provide three sets of equally-spaced radial slots.

14. A vehicle wheel according to claim 12 wherein the central opening and the slots are provided within a wheel hub portion.

15. A vehicle wheel according to claim 1 wherein the wheel is provided with a tyre.

16. A vehicle wheel according to claims 14 and 15 wherein the hub portion is connected to the tyre by one or more annular portions.

17.-23. (canceled)

24. A vehicle wheel according to claim 1 wherein the wheel comprises a central hub plate, a tapered/conical ring, a connection portion in the form of an outer plate, an outer rim and a tyre.

25. A vehicle wheel according to claim 14 wherein the slots and the hub portion is provided with an additional opening in the form of a circular hole which is offset from the central opening to ensure correct positioning of the wheel on the axle.

26.-28. (canceled)

29. A kit comprising a plurality of wheels according to claim 1.

30. A method of recovering a vehicle which comprises fitting one or more wheels according to claim 1.

31.-37. (canceled)
